(19) United States
(12) Patent Application Publication
(10) Pub. No.: US 2025/0093682 A1
(43) Pub. Date: Mar. 20, 2025

(54) SCLERAL LENS COMPRISING A COVER PORTION ENCAPSULATING ONE OR MORE ELECTRONIC COMPONENTS AND CONFIGURED TO LEAVE THE PUPIL OF THE LENS-WEARING EYE VISIBLE

(71) Applicants: INSTITUT MINES TELECOM, PALAISEAU (FR); LENTILLES, CAEN (FR)

(72) Inventors: Jean-Louis DE BOUGRENET DE LA TOCNAYE, GUILLERS (FR); Emmanuel VEILLARD, CAEN (FR); Vincent NOURRIT, BREST (FR); Laure ADAM, DOUVRES LA DELIVRANDE (FR)

(21) Appl. No.: 18/014,920

(22) PCT Filed: Jul. 7, 2021
(86) PCT No.: PCT/EP2021/068906

§ 371 Date: Jan. 6, 2023

(30) Foreign Application Priority Data
Jul. 8, 2020 (FR) FR2007227

(51) Int. Cl. G02C 7/04; G02C 11/00

(52) U.S. Cl. CPC G02C 7/04; G02C 11/10

(57) ABSTRACT

A scleral lens that includes a cover part suitable for covering the pupil, the iris and, at least partially, the sclera of an eye of an individual. The cover part includes a transparent central portion. At least one electronic component is encapsulated in a portion of the cover part. A lens in which the form and/or the dimensions of the cover part are configured, at least locally, as a function of the arrangement of the electronic component or components and, if appropriate, of the non-axis symmetrical form of the eye, such that the pupil is totally visible through the transparent central portion of the cover part, when the lens is worn by the eye.

### TECHNICAL FIELD

The present invention relates to a scleral lens, intended to be worn by the eye of an individual.

The lens according to the invention can be a fully autonomous system and embedded on at least one eye of an individual.

The invention aims in particular to enhance the contact lenses of which a part encapsulates one or more electronic components and do so in order to leave visible, that is to say not obstructed, the pupil of the eye which wears one of these lenses.

There are many applications of a scleral lens according to the present invention, among which the following can be cited: assistance in surgical work, driving assistance, human-machine interface, robotics, analysis of the attention and the fatigue of the subject, design of new human/machine interfaces: home automation, personal assistance (communication with patients affected by “locked-in syndrome” for example), vision assistance for the sight impaired, etc.

### PRIOR ART

Contact lenses of these days have become objects whose use widely exceeds the initial corrective function, to the benefit of new functions which make them a support platform for the encapsulation of various optoelectronic, physio-chemical and other such functions, for multiple applications: [1]. In many of these applications, a contact lens can thus carry a payload to perform various functions. For example, a lens can contain a payload of one or more electronic components, such as projectors, imaging devices, sensors, gyroscopes, batteries, micro-electromechanical systems MEMS, accelerometers and magnetometers, etc. In addition to the regulations covering ocular safety or cytological protection, that these encapsulations demand and which have already been the subject of clinical studies in simple cases [2], the ever-growing desire for the integration of increasingly more functions has an impact on the design of the contact lenses which must now incorporate these functions, but while leaving the pupil free.

The first consequence is the increase in the weight and/or the thickness of these lenses. The weight increase combined with the effect of gravity can cause a downward decentering of the lens.

The increase in thickness can have a similar effect due to the pressure exerted by the upper eyelid which bears more on the lens.

The consequence of one and/or the other of these increases is an undesirable decentering of the lens with respect to the pupil which can lead to a partial, even total, obstruction of the pupil.

That is illustrated in FIG. 1 which shows a contact lens 1 whose material 10 comprises a transparent central portion 11 and which encapsulates several electronic components 12 distributed primarily on an annular portion 13. As illustrated, the lens 1 is decentered downward when being placed on the eye (O) and comes to be somewhat wedged on the bottom. The pupil (P) of the eye is partially obstructed by a non-transparent membrane zone 100.

In addition to this problem of undesirable decentering, the incorporation of electronic components in contact lenses raises many issues.

In addition to the technical problems of integration, the contact lenses can present drawbacks such as problems of tolerance, of discomfort, etc., for the individuals who wear them. Indeed, the conventional contact lenses are manufactured, either in a flexible hydrophilic material, or in a rigid material, and are in contact with the cornea. Since the latter is highly sensitive and very fragile, the tolerance to the contact lenses is highly variable according to the individual. Moreover, the possible movement of these lenses on the eye creates a limiting random factor when it comes to considering the development of a lens with integrated electronic component(s).

The known scleral lenses are lenses of larger dimensions, as shown in FIG. 2, with an inner face 14 and an outer face 15 of the cover part 10 which define a general spherical cap form. These scleral lenses 1 are not in contact with the cornea, with a space E typically of a few hundreds of microns between the surface of the cornea and the inner face 14 of the lens 10, and the peripheral portion 16 of the lens 10 rests evenly on the sclera, as shown in FIG. 3.

These two characteristics make these lenses very comfortable and very stable on the eye. For placement, the scleral lenses are filled with physiological serum or an ophthalmic hydrating solution. This makes it possible to create a reservoir of liquid under the lens which keeps corneal surface permanently hydrated. This has thus become the therapeutic recommendation of choice for the corneal surface pathologies such as severe ocular dryness syndrome. The proofs of good physiological and subjective tolerance for this category of lenses are no longer required. Thus, extending use of scleral lenses incorporating electronic components makes it possible to overcome the comfort problems commonly encountered among new wearers of lenses.

Thus, the inventors have already prioritized the scleral lenses for their automatic system for detecting the direction of the gaze of an individual as described and claimed in the international patent application filed on Apr. 15, 2020 under the number PCT/EP2020/060541 in the name of the applicant.

That being the case, in many cases of integration of electronic components, the implementation of known scleral lenses cannot resolve the issue of undesirable decentering as described above.

Furthermore, it is now known that many eyes do not exhibit surface axis symmetry beyond the cornea. Indeed, the sclera does not exhibit the same form or curvature in all the meridians, which can result in non-optimal positioning and stability of a contact lens.

There is therefore a need to enhance the scleral lenses, the cover part of which encapsulates one or more electronic components, notably in order to overcome the abovementioned drawbacks.

The aim of the invention is to at least partly address this need.

### SUMMARY OF THE INVENTION

For this, the invention relates in one of its aspects to a scleral lens comprising:
a cover part suitable for covering the pupil, the iris and, at least partially, the sclera of an eye of an individual, the cover part comprising a transparent central portion;
at least one electronic component encapsulated in a portion of the cover part, a lens in which the form and/or the dimensions of the cover part are configured, at least locally, as a function of the arrangement of the electronic component or components and, if appropriate, of the non-axis symmetrical form of the eye, such that the pupil is totally visible through the transparent central portion of the cover part, when said lens is worn by the eye. A “scleral lens” is understood here, and in the context of the invention, by the usual meaning, to be namely a contact lens of large diameter which, in the configuration worn by the eye, bridges over the cornea without touching it, by bearing on the sclera of the eye.

The scleral lens according to the invention can be rigid or hybrid (semi-rigid).

Advantageously, the cover part is formed to delimit, between the cornea and the cover part, a free space (E) forming a reservoir. The space E of a few hundreds of microns between the surface of the cornea and the inner face of the cover part of the lens makes it possible to consider the integration of multiple electronic components for different applications with a safety buffer zone. Thus, with such a space, a scleral lens according to the invention offers a greater encapsulation volume than the traditional contact lenses and is above all more stable.

In order to optimize the adaptation of a scleral lens to eyes of non-axis symmetrical form over the cornea, it is advantageous to take into consideration the geometrical characteristic of dissymmetry for the design of the scleral lens, and do so in particular if its diameter exceeds 15 mm.

To this end, it is preferable for the design of the inner face of the scleral lens, and more particularly that of the peripheral portion which will provide the bearing with the sclera, to allow optimal positioning and stabilization on a non-axis symmetrical eye.

Thus, according to a first advantageous embodiment, at least the inner face of the cover part has a general asymmetrical form.

According to this first embodiment and an advantageous variant embodiment, at least one of the four quadrants of the cover part has a form distinct from the other quadrants.

“Quadrant” is understood here, and in the context of the invention, to mean an angular segment of the cover part measuring 90 degrees.

According to a second advantageous embodiment, at least the inner face of the cover part has, at least locally, a toric surface.

According to this second embodiment and an advantageous variant embodiment, the cover part has at least one flat meridian and at least one cambered meridian, arranged at 90° from the flat meridian.

According to another embodiment, the encapsulation portion of the electronic component or components of the cover part made thicker with respect to the rest of the cover part extends according to a non-circular form around the transparent central portion. In other words, advantageously the mass of the electronic component or components is distributed non-uniformly.

Several advantageous variant embodiments can be envisaged for this non-uniform distribution of material. Thus, the encapsulation portion can extend around the transparent central portion, by choice:
according to an elliptical form whose large axis is on the transverse axis of the eye;
according to a general form in front view delimited by a ring apart from in a crescent-shaped zone opposite the upper zone of the pupil;
according to a general form in front view delimited by a pear-shaped quartic. This latter form is also commonly called a droplet form.

The scleral lens according to the invention can incorporate a battery, in order to form a fully autonomous system embedded on at least one eye of an individual.

Advantageously, the battery is a deformable accumulator, encapsulated in the membrane. It can be an accumulator described and claimed in the patent application WO 2018/167393 A1. Such an accumulator has the advantage of being of very small dimensions, typically with a surface area of the order of 0.75 cm². This flexible battery also has the advantageous characteristics of being stretchy and self-repairable so as to be best incorporated in the contact lens and be able to ensure sufficient battery life for the operation of the illumination sources.

According to a particularly advantageous embodiment, the cover part is composed of two pucks assembled together defining the portion in which the electronic component or components is/are encapsulated, one and/or the other of the two pucks comprising, in their zone delimiting the transparent central portion, a bonding polymer material whose refractive index is chosen so as not to generate a diopter in said central portion.

Another subject of the invention is an automatic system for detecting the direction of the gaze of an individual comprising at least one scleral lens as described previously. It is therefore a system which will automatically, i.e. once programmed and without human intervention, detect the direction of the gaze of an individual.

Thus, the invention consists essentially in defining a scleral lens whose form and/or dimensions of the cover part are modified with respect to a known axis symmetrical form by taking account of the mass of the embedded electronic components, and advantageously a possible non-axis symmetrical form of the eye which will wear the lens, in order to guarantee that the pupil is fully cleared and there is no undesirable movement on the eye.

In other words, by virtue of a scleral lens according to the invention, the vision of the individual who wears it will not be affected by an obstruction of the pupil, and this regardless of the embedded electronic components.

Indeed, unlike a standard contact lens, a scleral lens, in a configuration worn by an eye, extends beyond the iris to just under the eyelids. To leave the pupil visible, that is to say leave free the axis of the pupil, for example for a pupil diameter of the order of 5 mm, there is, in a scleral lens according to the prior art which has an axis symmetrical form, a location in the form of a ring of inner diameter corresponding to that of the pupil and of outer diameter close to that of the full cover part for encapsulating electronic components, for example an electronic circuit. Because of the additional weight of the electronic components, an axis symmetrical scleral lens according to the state of the art can, once placed on the eye, drop and partially obstruct the pupil.

The modification, at least locally, of the form and/or the dimensions of the cover part of the lens according to the invention makes it possible to counteract the gravity, by distributing the mass of the electronic components non-uniformly.

Other advantages and features of the invention will become more apparent on reading the detailed description of examples of implementation of the invention given in an illustrative and nonlimiting manner with reference to the following figures.

### BRIEF DESCRIPTION OF THE DRAWINGS

FIG. 1 is a photographic reproduction of an example of contact lens incorporating electronic components according to the state of the art placed on an eye.

FIG. 2 is a perspective schematic view of a scleral lens according to the state of the art, in the general form of a spherical cap.

FIG. 3 is a cross-sectional view illustrating a scleral lens according to the state of the art placed on an eye.

FIG. 4 is a perspective schematic view of a scleral lens according to a first embodiment of the invention, the lens having a toric surface.

FIG. 5 is a top view of FIG. 4.

FIG. 6 is a perspective schematic view of a scleral lens according to a second embodiment of the invention, the lens having an asymmetric form.

FIG. 7 is a top view of FIG. 6.

FIG. 8 is a front schematic view of a scleral lens according to the state of the art, in the general form of a spherical cap in an ideal configuration worn by an eye.

FIG. 9 is a front schematic view of a scleral lens according to the state of the art, in the general form of a spherical cap in a real configuration worn by an eye.

FIG. 10 is a front schematic view of a scleral lens according to a first variant of the invention, in a real configuration worn by an eye.

FIG. 11 is a front schematic view of a scleral lens according to a second variant of the invention, in a real configuration worn by an eye.

FIG. 12 is a front schematic view of a scleral lens according to a third variant of the invention, in a real configuration worn by an eye.

FIG. 13 is a front schematic view of a scleral lens according to a fourth variant of the invention, in a real configuration worn by an eye.

### DETAILED DESCRIPTION

Throughout the present application, the terms “inner” and “outer” should be understood by reference to a scleral lens in a configuration worn by an eye. Thus, the inner face designates the face of the lens in contact with the surface of the eye while the outer face designates the face in contact with the outside.

Likewise, the terms “above”, “below”, “high”, “low” should be understood by reference to a scleral lens in a configuration worn by an eye whose optical axis is substantially horizontal. “Optical axis of the eye” is understood here, and in the context of the invention, to be an axis identified in clinical practice as the direction linking a light source point, and the center of the light reflections of the four refractive surfaces of the eye (anterior and posterior faces of the cornea, anterior and posterior faces of the crystalline lens).

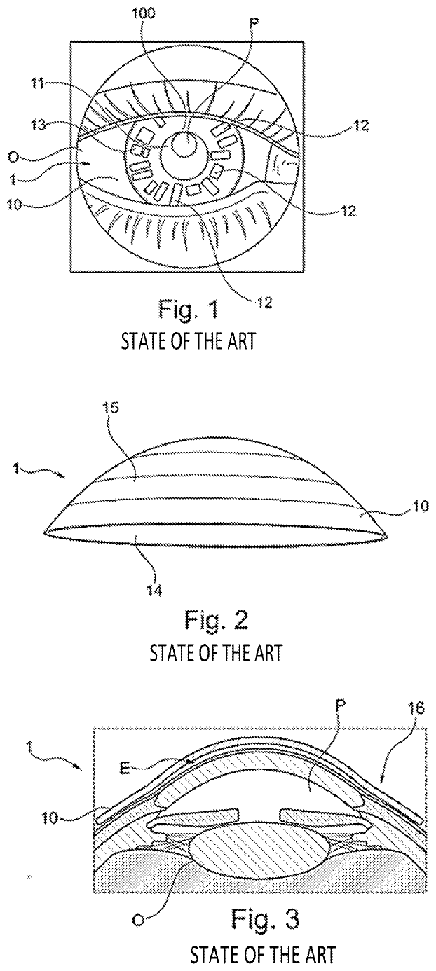

FIGS. 1 to 3 have already been commented on in the introduction. They are not detailed hereinbelow.

In the interests of clarity, one and the same element according to the prior art and according to the invention is designated by the same numeric reference, in the various figures.

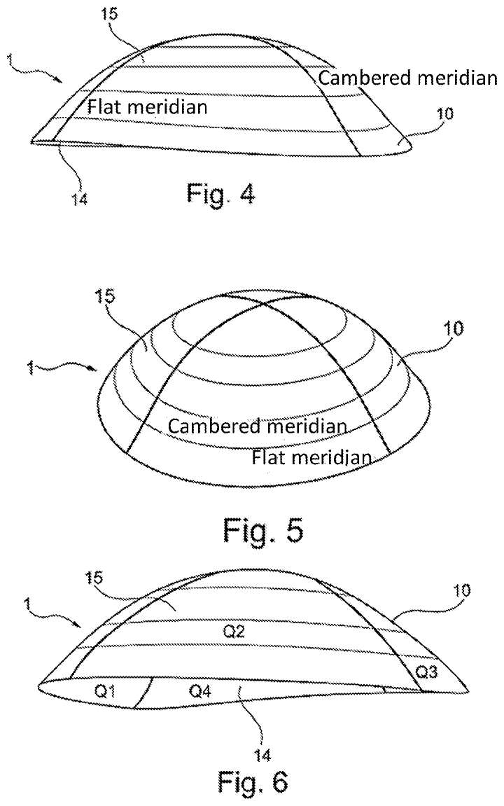

In the various FIGS. 4 to 11, the electronic components, notably the electronic circuit or circuits, encapsulated in the cover part of a scleral lens are not represented as such, only the portions of the cover part affected by the placement of said components are symbolically represented.

FIGS. 4, 5, 6 and 7 show two distinct embodiments of a scleral lens 1 intended to be worn by the eye of an individual, which does not have an axis symmetrical form beyond the cornea. In such a case, the sclera does not have the same form or curvature in all the meridians.

The scleral lenses 1 have an inner face 14, in particular the bearing zone with the sclera, adapted for optimal positioning and stabilization on the eye.

The cover part 10 of the scleral lens 1 according to FIGS. 4 and 5 has a flat meridian and at least one cambered meridian, arranged at 90° from the flat meridian.

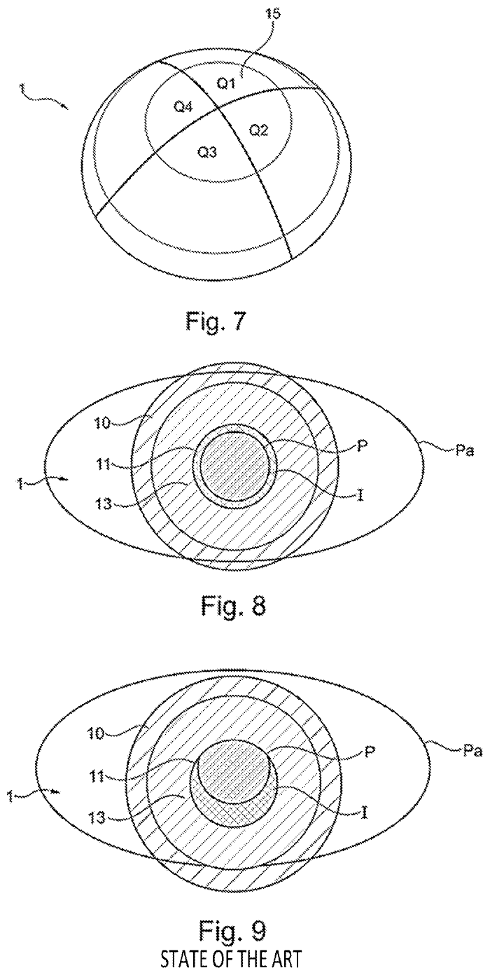

The cover part 10 of the scleral lens 1 according to FIGS. 6 and 7 comprises four quadrants of which at least one of the quadrants has a form distinct from the other quadrants.

Furthermore, in order to reduce the pressure exerted by the upper eyelid of the eye on a scleral lens 1 according to FIGS. 4 to 7, the cover part 10 of which can be very thick, it is preferable to adapt the profile of the outer face 14 in order to reduce as much as possible the top protuberance which results from the encapsulations of the electronic components. A trade-off can be found between a relatively smooth outer face surface and an addition of encapsulation material, in order to reduce the weight added to the cover part as such of the lens.

Moreover, unlike a conventional contact lens, a scleral lens extends beyond the iris (I) to just under the eyelids (Pa), because of the greater diameter. The diameter (D) of a scleral lens is generally around 15-18 mm.

With the scleral lenses as designed hitherto, if it is assumed that there is a need to leave completely visible the pupil (P) of an eye which wears it, for a pupil diameter of 5 mm for example, that therefore leaves a ring 13 around the transparent central portion 11 of the cover part 10 of the lens for encapsulating electronic components, for example an electronic circuit (FIG. 8).

Now, the inventors have found that, because of the additional weight of the encapsulated components, a standard scleral lens 1 can drop and come to partially obstruct the pupil P (FIG. 9).

So, in order to counteract the gravity, the inventors thought to distribute the mass of the components non-uniformly in the encapsulation portion 13 of a scleral lens.

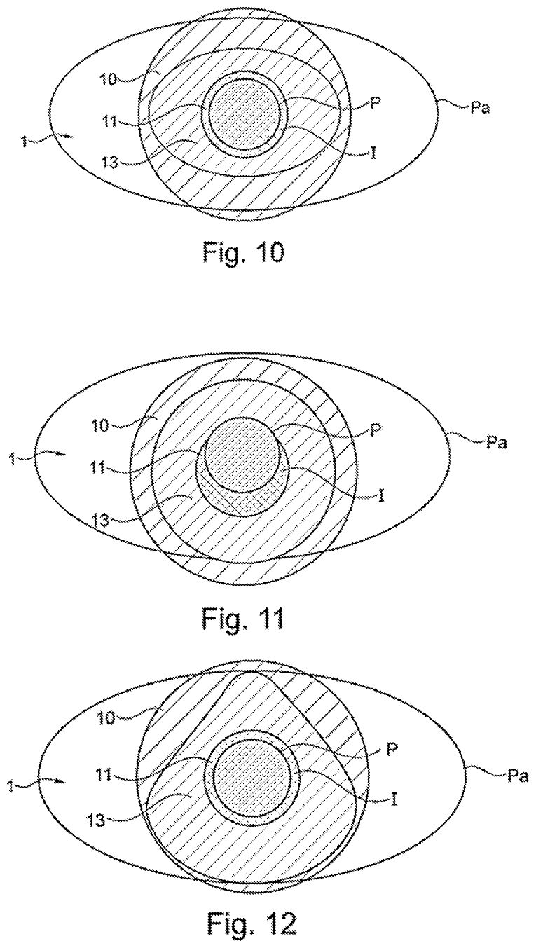

FIGS. 10 to 13 show different alternative implementations of this non-uniform distribution around the circular transparent central portion 11.

A first alternative consists in producing the encapsulation portion 13 around the transparent central portion 11, according to an elliptical form whose large axis is on the transverse axis of the eye (FIG. 10). Thus, the peripheral portion of the cover part 10 is thinner under the eyelids (Pa) and because of this the lens 1 is better held and does not therefore come to obstruct the pupil (P).

A second solution consists in placing neither encapsulation material nor electronic components, inside the lens, in a zone which would block the pupil. Advantageously, the encapsulation portion 13 extending around the transparent central portion 11 according to a general form in front view delimited by a ring apart from in a crescent-shaped zone opposite the upper zone of the pupil (P) (FIG. 11). In other words, this crescent-shaped zone is delimited by the intersection of the pupil (P) and of the encapsulation portion 13.

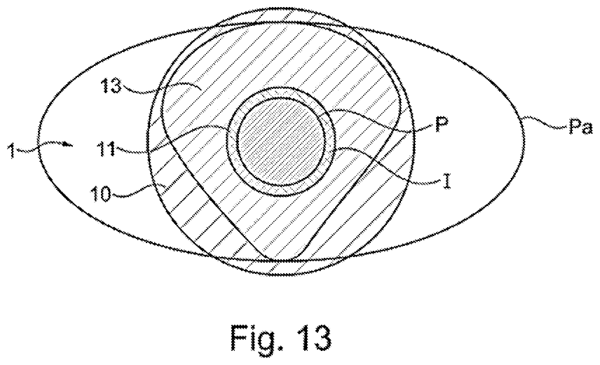

Another solution consists in limiting the movement of the lens. In the case of the toric scleral lenses, provision can be made to have a thicker cover part in the bottom part of the lens, that is to say with an encapsulation portion 13 of the electronic components which is greater in the bottom part of the lens (FIG. 12). By this means, gravity and the pressure of the upper eyelid on the lens 1 hold it in place. Alternatively, the material of the encapsulation portion 13 of the cover part 10 can be primarily arranged for it to come to be positioned under the upper eyelid (FIG. 13).

Advantageously, as illustrated in FIGS. 12 and 13, the encapsulation portion 13 extends around the transparent central portion 11 according to a general form in front view delimited by a pear-shaped quartic.

Other solutions can be envisaged for non-uniformly distributing the mass of the electronic components in the membrane. For example, it is possible to envisage modifying the internal toricity of the cover part 10, in order to create a slight suction effect which will hold the scleral lens on the eye while being centered on the pupil P.

An advantageous method for producing a scleral lens according to the invention is now described.

A set of two pucks is used, in which the raw material is usually implemented for the manufacture of rigid contact lenses. It can for example involve materials having at least one polymer base.

This set of pucks comprises a so-called hollow puck, the profile of which is defined according to the nature and the design of the electronic component or components to be encapsulated, and a male puck whose profile is matched to that of the hollow puck and of the electronic component or components to be encapsulated. The encapsulation is done via process of polymerization of a so-called bond material.

After machining, the pucks can undergo an additional step in order to prepare them to undergo specific stresses linked to the assembly process and/or to the encapsulated electronic function. That for example necessitates non-uniform volumes with positioning and/or alignment pins, possibly peripheral drains/grooves for evacuating air and/or excess bonding polymer material during the phase of compression of the two pucks.

In order to obtain a transparent central portion 11 there is an additional diopter formed upon the assembly between the pucks, at least one bonding polymer material of refractive index equivalent to that of the pucks is implemented in their zone of contact delimiting said portion 11.

To obtain the assembly of the two pucks with the desired encapsulation of the electronic component or components, a compression force is applied between them.

More specifically, during assembly, the hollow puck is placed in a bottom insert of a compression device, the male puck in a top insert. A few drops of bonding polymer are deposited on the periphery of the hollow puck. This polymer can for example be an acrylate base.

The frame of the device then applies a compression force to allow bonding for a determined time dependent on the materials used for the pucks and for the bonding material.

Once the two have been assembled the block resulting from this assembly can be machined. Obviously, the invention is not limited to the exemplary implementations which have just been described.

Other variants and enhancements can be envisaged without in any way departing from the scope of the invention.

For example, a scleral lens according to the invention can have a diameter (D) of around 15 mm to 18 mm but larger values can be envisaged, notably with a diameter great enough to entirely cover the white of the eye.

The invention is not limited to the examples which have just been described; it is notably possible to combine together features of the examples illustrated with variants that are not illustrated.

### LIST OF DOCUMENTS CITED

[1]: N. M. Farandos et al., “Contact lens sensors in ocular diagnostics”, Advanced Healthcare Materials, vol. 4, no. 6, 4, pp. 792-810, April 2015.
[2]: Dunbar, G. E., Shen, B. Y. and Aref, A. A., “The Sensimed Triggerfish contact lens sensor: efficacy, safety, and patient perspectives.”, Clinical ophthalmology (Auckland, NZ), 11, p.875, 2017.

1. A scleral lens comprising:
a cover part suitable for covering the pupil, the iris and, at least partially, the sclera of an eye of an individual, the cover part comprising a transparent central portion;
at least one electronic component encapsulated in a portion of the cover part, a lens in which the form and/or the dimensions of the cover part are configured, at least locally, as a function of the arrangement of the electronic component or components and, if appropriate, of the non-axis symmetrical form of the eye, such that the pupil is totally visible through the transparent central portion of the cover part, when said lens is worn by the eye.

2. The scleral lens as claimed in claim 1, wherein the scleral lens is rigid or hybrid.

3. The scleral lens as claimed in claim 1, wherein the cover part is formed to delimit, between the cornea and the cover part, a free space (E) forming a reservoir.

4. The scleral lens as claimed in claim 1, wherein at least the inner face of the cover part has a general asymmetrical form.

5. The scleral lens as claimed in claim 4, wherein at least one of the four quadrants of the cover part has a form distinct from the other quadrants.

6. The scleral lens as claimed in claim 1, wherein at least the inner face of the cover part has, at least locally, a toric surface.

7. The scleral lens as claimed in claim 5, wherein the cover part has at least one flat meridian and at least one cambered meridian, arranged at 90° from the flat meridian.

8. The scleral lens as claimed in claim 1, wherein the encapsulation portion of the electronic component or components of the cover part made thicker with respect to the rest of the cover part extend according to a non-circular form around the transparent central portion.

9. The scleral lens as claimed in claim 8, wherein the encapsulation portion extends around the transparent central portion according to an elliptical form whose large axis is on the transverse axis of the eye.

10. The scleral lens as claimed in claim 8, wherein the encapsulation portion extending around the transparent central portion according to a general form in front view delimited by a ring apart from in a crescent-shaped zone opposite the upper zone of the pupil (P).

11. The scleral lens as claimed in claim 8, wherein the encapsulation portion extends around the transparent central portion according to a general form in front view delimited by a pear-shaped quartic.

12. The scleral lens as claimed in claim 1, wherein the cover part is composed of two pucks assembled together defining the portion in which the electronic component or components is/are encapsulated, one and/or the other of the two pucks comprising, in their zone delimiting the transparent central portion, a bonding polymer material whose refractive index is chosen so as not to generate a diopter in said central portion.

13. An automatic system for detecting the direction of the gaze of an individual comprising at least one scleral lens as claimed in claim 1.
